(19) United States
(12) Patent Application Publication
(10) Pub. No.: US 2017/0014954 A1
(43) Pub. Date: Jan. 19, 2017

(54) BRAZING THREE-DIMENSIONAL PRINTER

(71) Applicants: Uriel Aba Pomerantz, Kefar Sava (IL); Itzhak Pomerantz, Kefar Sava (IL)

(72) Inventors: Uriel Aba Pomerantz, Kefar Sava (IL); Itzhak Pomerantz, Kefar Sava (IL)

(21) Appl. No.: 15/212,240

(22) Filed: Jul. 17, 2016

Related U.S. Application Data
(60) Provisional application No. 62/193,087, filed on Jul. 16, 2015.

(51) Int. Cl. B23K 35/02; B33Y 70/00; B33Y 10/00; B32B 7/04; B23K 1/00; B32B 37/30; B32B 37/18; B32B 38/04; B32B 38/10; B33Y 80/00; B32B 15/01

(52) U.S. Cl. CPC B23K 35/0238; B33Y 80/00; B33Y 70/00; B33Y 10/00; B32B 7/04; B32B 15/016; B32B 37/30; B32B 37/18; B32B 38/04; B32B 38/10; B23K 1/00; B32B 2038/047; B32B 2311/24; B23K 2201/35

(57) ABSTRACT

Disclosed herein are methods, systems, and materials for high resolution three dimensional printing of metals using low cost raw material. The method employs masked brazing foils having structural layers, melting layers, and in some embodiments masking layers. The foils are selectively joined by brazing to form three dimensional metal objects. Some of the embodiments differ in the number of structural and/or melting layers in the foils, how masks are formed, and how many brazing steps are employed. Etching removes foil material that is not to remain as part of the final three dimensional object, and various embodiments are disclosed for applying the etchant.

### RELATED APPLICATION

This application claims priority under 35 U.S.C. §119(e) to U.S. Provisional Application No. 62/193,087, filed Jul. 16, 2015, which is hereby incorporated by reference in its entirety.

### BACKGROUND

Three dimensional printers are known as machines that automatically fabricate physical objects from computer files without additionally programming the machine with step-by-step instructions.

Three dimensional printers use several different technologies for building the objects and for supporting them in space. Almost all of the technologies build the objects by horizontal layering, and they differ in the way the layers are set in place and the way overhanging areas of the model are supported during the building process. The variety of materials used in three dimensional printers is currently limited by the chemical properties required by the printer instead of by the chemical properties desired by the user. For example, some build materials need to have a specific melting point, some need to be photopolymers, some need to be sinterable powders, and some need to be made of gluable sheets comprising a substrate sheet of one material and a glue of a different material.

Some of the most important and useful materials for building models, molds, and other products are aluminum alloys. Aluminum is light, conducts electricity and heat, is machinable, and can be welded. Unfortunately, known methods of aluminum-based three dimensional printing have significant disadvantages, such as the following: Sintering metal powder is a messy process, the fine powder used as raw material for the process is expensive, and the sintered end product tends to be porous. The powder also poses health hazards, such as danger from inhalation, and further the powder is explosive. Printing by welding also has low resolution, and it requires a great amount of power.

It would be very desirable to have a method of direct three dimensional printing of aluminum, using low cost raw material, and obtaining high resolution and full, bulk, non-porous materials.

### SUMMARY

The present inventors developed methods, systems, and materials for three dimensional printing of metals using low cost raw material and obtaining high resolution and full, bulk, non-porous materials.

The invention may be embodied as a method of building at least one three dimensional metal object. The method includes: setting in place a first foil having at least one structural layer and at least one melting layer; setting in place a second foil on the first foil, the second foil having at least one structural layer and at least one melting layer; designating as first areas regions of the first and second foils to remain unjoined to each other; compressing and heating the first and second foils so that second areas of the first and second foils, distinct from the first areas, become joined to each other by brazing; and removing the first areas to form at least one three dimensional object.

The invention may also be embodied as a three dimensional metal object. The three dimensional object has multiple metal sheets. The metal sheets are joined together by selective brazing.

The invention may further be embodied as a masked brazing foil. The masked brazing foil has: at least one structural layer; at least one melting layer; and at least masking layer.

Embodiments of the present invention are described in detail below with reference to the accompanying drawings, which are briefly described as follows:

### BRIEF DESCRIPTION OF THE DRAWINGS

The invention is described below in the appended claims, which are read in view of the accompanying description including the following drawings, wherein:

FIGS. 1-6 illustrate foils in accordance with various embodiments of the invention;

FIG. 7 illustrates a stack of pre-cut foil sheets in accordance with another embodiment of the invention;

FIG. 8 illustrates a cylindrically wound roll of foil in accordance with yet another embodiment of the invention;

FIG. 9 illustrates transferring a single foil sheet in accordance with still another embodiment of the invention;

FIG. 10 illustrates adding a layer of foil from a supply roll to a build area in accordance with an embodiment of the invention;

FIG. 11 illustrates a cross section of an object made of layers in accordance with an embodiment of the invention;

FIG. 12 illustrates a cross section of an object being built where layers are joined to each other in accordance with an embodiment of the invention;

FIG. 13 illustrates a cross section of a fully printed object in accordance with an embodiment of the invention;

FIG. 14 illustrates a fully printed object after excess material has been removed in accordance with an embodiment of the invention;

FIG. 15 illustrates a way to introduce etchant to manufacture an object in accordance with an embodiment of the invention;

FIGS. 15a-c are used for reference in the discussion of alternate ways to introduce etchant to the object; and

FIG. 16A-H are referenced in the discussion of alternate embodiments for the manufacture of three dimensional objects.

The figures are not necessarily drawing to scale.

### DETAILED DESCRIPTION

The invention summarized above and defined by the claims below will be better understood by referring to the present detailed description of embodiments of the invention. This description is not intended to limit the scope of claims but instead to provide examples of the invention.

The present description uses the following terms presented with their definitions:
Three dimensional printer—a machine that builds a three dimensional object in an additive process.
Metal Joining—a collective name for the processes of brazing, joining, fusing, etcetera two metal objects to each other to create a continuous metallic object.
Brazing—Brazing is a joining process wherein metals are bonded together using a filler metal with a melting (liquidus) temperature greater than 450° C. (840° F.), but lower than the melting temperature of the base metal. Filler metals are generally alloys of silver (Ag), aluminum (Al), gold (Au), copper (Cu), cobalt (Co), or nickel (Ni).
Soldering—a process similar to brazing conducted at a lower temperature.
Fusing—a process of joining two metal objects by applying heat and pressure without reaching the melting temperature of any of the metal objects involved.
Build area—The active area of an object being produced by a 3D printer, where new material is being added to the object layer by layer.
Wettability—the ability of a molten material to adhere to a solid material and remain fused to it when solidified or the ability of two solid materials to fuse together under pressure at a temperature lower than the melting point of either solid material.
Structural layer (of a metal foil)—a layer in a metal foil that is intended to become a portion of the body of the built object produced by a 3D printer, such as a part of the metal foil made of 6061 type aluminum alloy.
Melting layer (of a metal foil)—a layer in a metal foil that has a lower melting temperature than the structural layer and can wet a structural layer when placed in contact with it under sufficient pressure and/or temperature, for example, 12% silicon aluminum alloy (when the structural layer is a 6061 type aluminum alloy). A melting layer also fuses into an adjacent melting layer of another foil.
Masking layer (of a metal foil)—an outer layer in a metal foil that can withstand the melting temperature of the melting layer and essentially cannot be wetted by a melting layer of an adjacent foil. Example masking layer materials include aluminum oxide, silica (SiO₂) film, and anodized aluminum coating.

The present invention may be embodied as a method and system for building three dimensional objects of various shapes from metal foils, such as foils made of aluminum. While the present disclosure often uses the term “aluminum” to describe the raw material of some embodiments, it should be understood that the method and system described hereinbelow apply to any metal or metallic alloys that can be used in foils.

The basic raw material for some embodiments of the present invention is a thin foil (typically 10-200 microns thick) made of two or more layers of metal or metallic alloy. The metals/metallic alloys are selected such that (1) at least one of the outer layers has a melting temperature that is significantly lower than at least one of the other layers of the foil and (2) that one of the outer layers, when melted, has the ability to wet an outer layer of an adjacent foil.

A detailed description of the drawings is as follows:

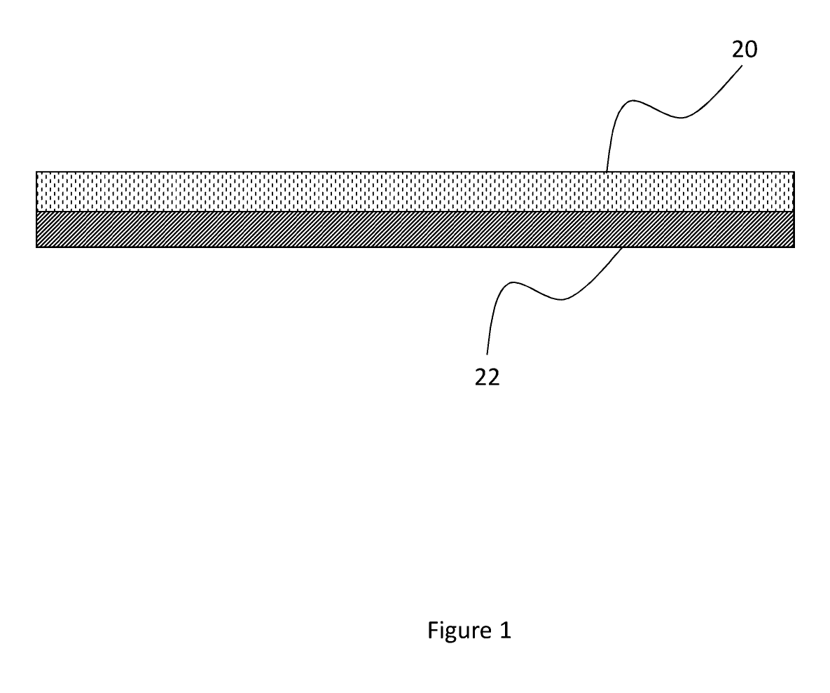

FIG. 1 shows a cross section of a foil where one outer, that is, exterior, layer 20 is a melting layer, and the other outer layer 22 is a structural layer. There is no inner, that is, interior, layer in this embodiment.

In one implementation of the embodiment the two layers are supplied at least partially fused into each other such as a clad metal sheet as available from Alcoa under catalog number Alloy QQ-A-250/13, where a 7075 type aluminum alloy core is clad on both sides by 7072 type aluminum alloy. This type of sheet is conventional.

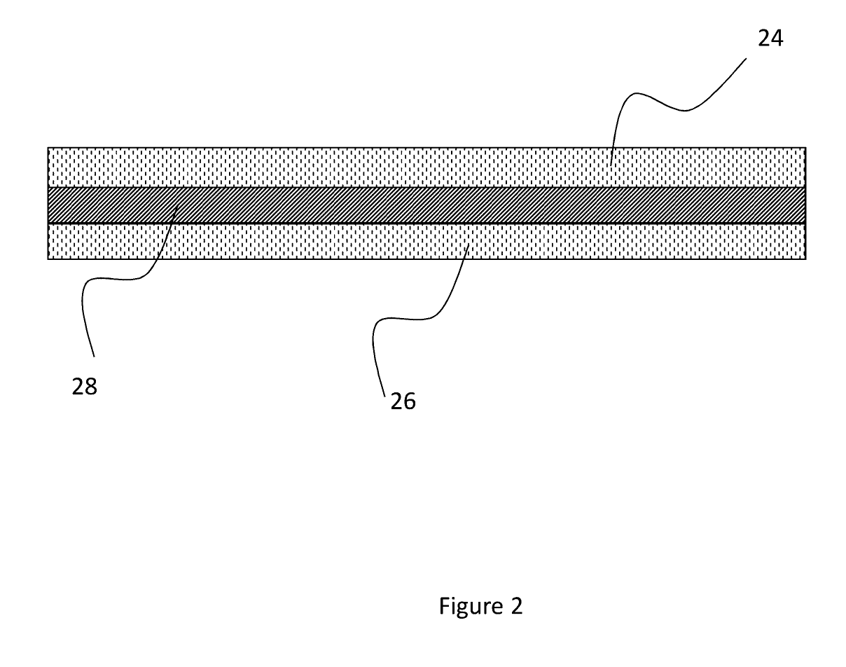

FIG. 2 shows a cross section of a foil where both outer layers 24 and 26 are melting layers, and the inner layer 28 is a structural layer. This type of foil is also conventional and is offered by Alcoa (www.alcoa.com)

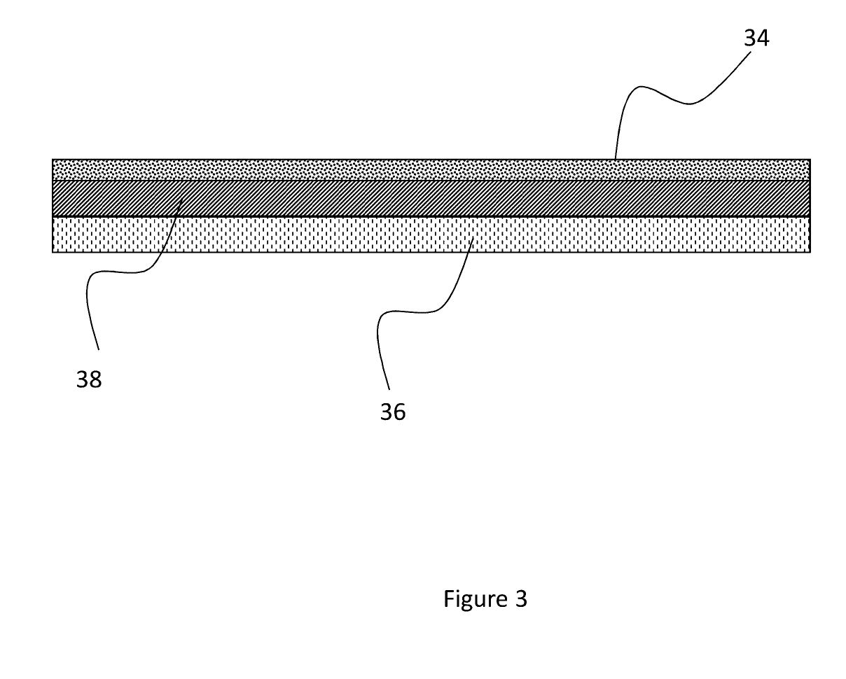

FIG. 3 shows a cross section of a foil of a preferred embodiment of the present invention, where one outer layer 36 is a melting layer and one inner layer 38 is a structural layer and the other outer layer 34 is a masking layer.

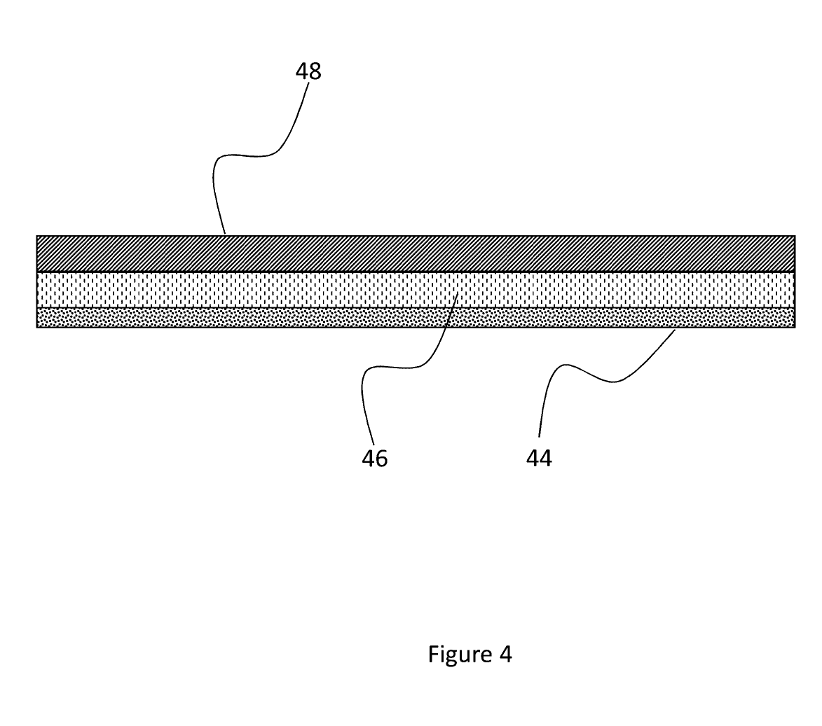

FIG. 4 shows a cross section of a foil of a preferred embodiment of the present invention, where one outer layer 48 is a structural layer and one inner layer 46 is a melting layer and the other outer layer 44 is a masking layer.

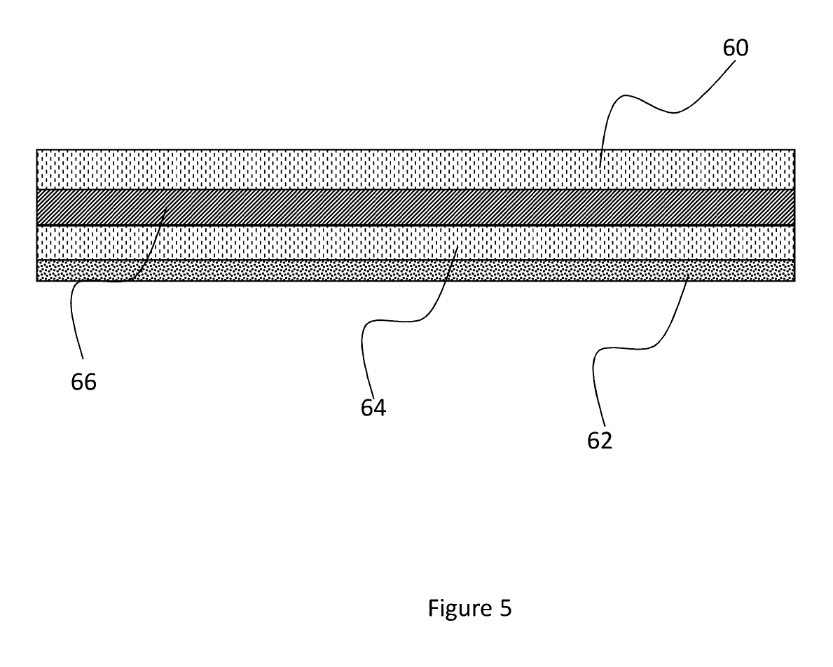

FIG. 5 shows a cross section of a foil of a preferred embodiment of the present invention, where one outer layer 60 and one inner layer 64 are melting layers, one inner layer 66 is a structural layer and the other outer layer 62 is a masking layer.

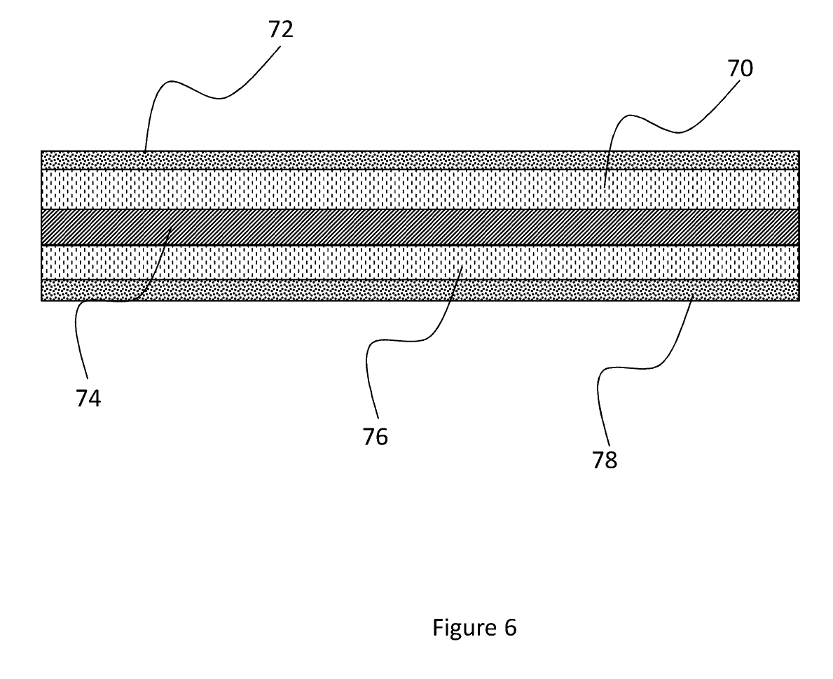

FIG. 6 shows a cross section of a foil of a preferred embodiment of the present invention, which has five layers. The central layer 74 is a structural layer, the two layers on both of its sides 70 and 76 are melting layers, and the two outer layers 72 and 78 are masking layers.

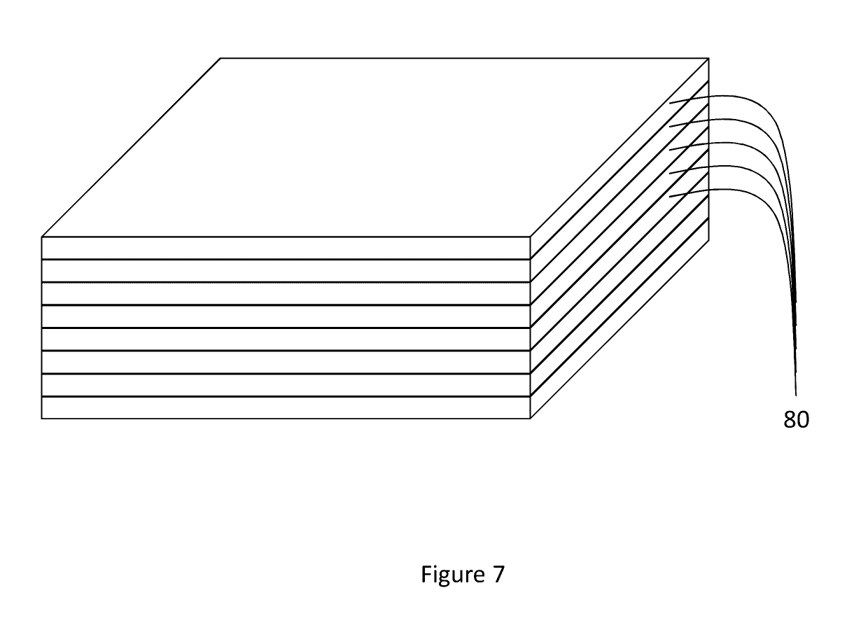

FIG. 7 shows a stack of pre-cut foil sheets 80. The sheets can be of any of the types shown in FIGS. 1-6. If the stack is kept below the melting point, the sheets remain unjoined and can be taken one after the other from the top of the stack and used in the method described below. The production process may treat the surface of the foil to remove surface oxides, and the stacking is done in an oxygen free environment. Once stacked, the surface of each sheet is protected by the neighboring sheets from exposure to oxygen. Optionally, the edges of the stack are sealed to prevent exposure to oxygen at the edges of the foil. This is done as oxidation of the material may inhibit the wetting ability of the melting layer and the structural layer.

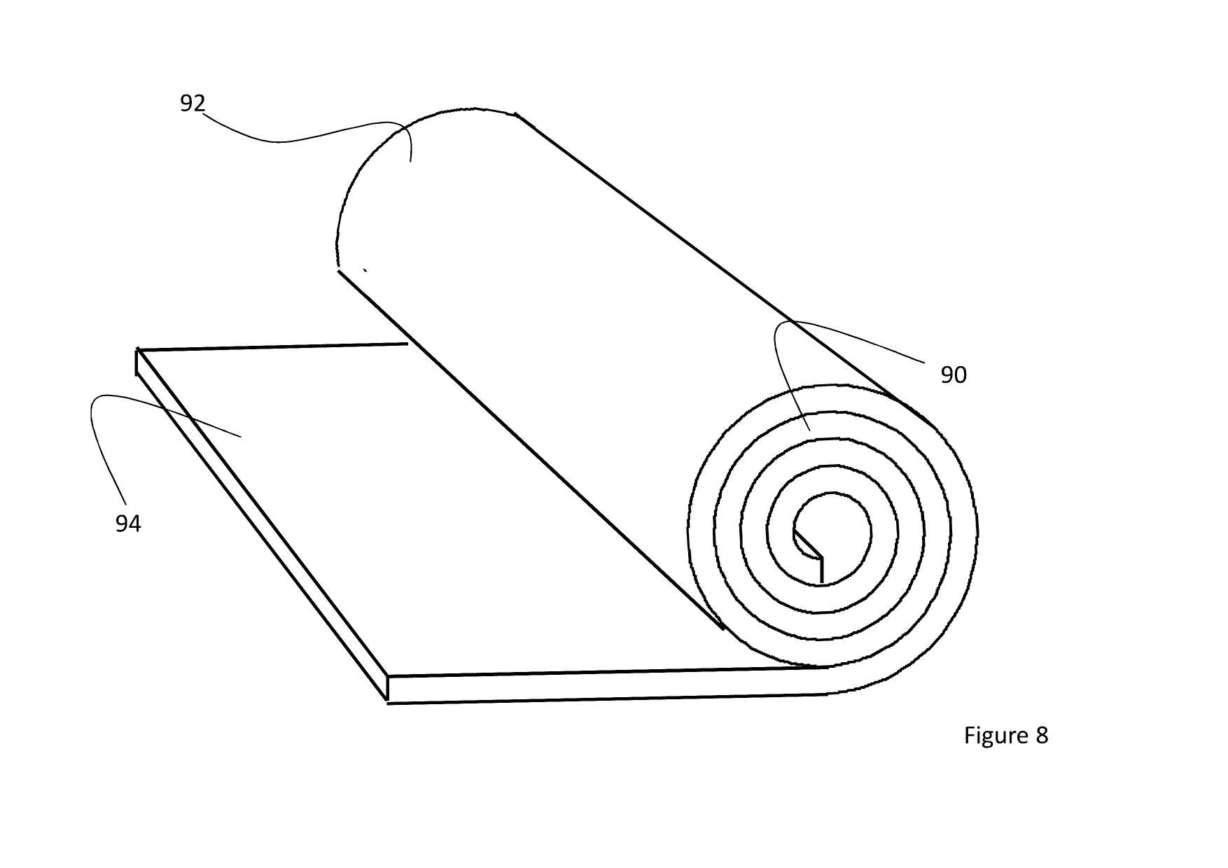

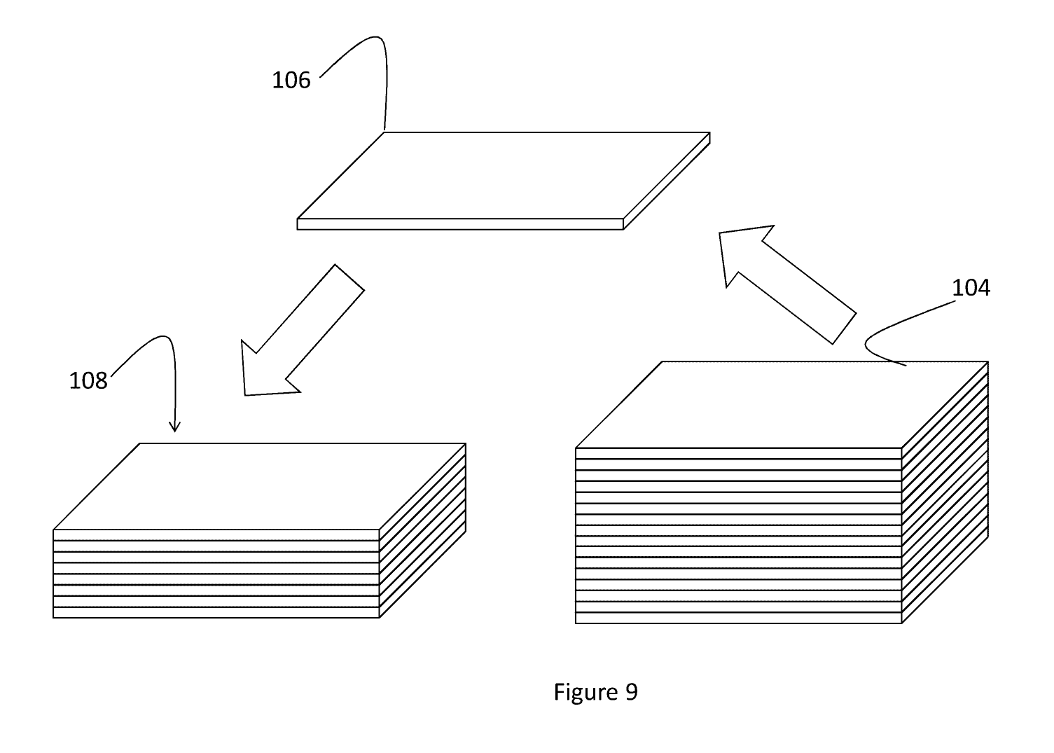

FIG. 8 shows a cylindrically wound roll 92 of a foil 90 of any of the types shown in FIGS. 1-6. The end of the roll 94 can be unwound out of the roll and used for the printing process described below. The production of the roll may use the same process to protect the foil from oxidation as described in FIG. 7.

FIG. 9 shows the process of transferring a single foil 106 from the raw material stack 104 (such as described in FIG. 7) to the build area 108 of a three dimensional printer, where it will become a part of the built object.

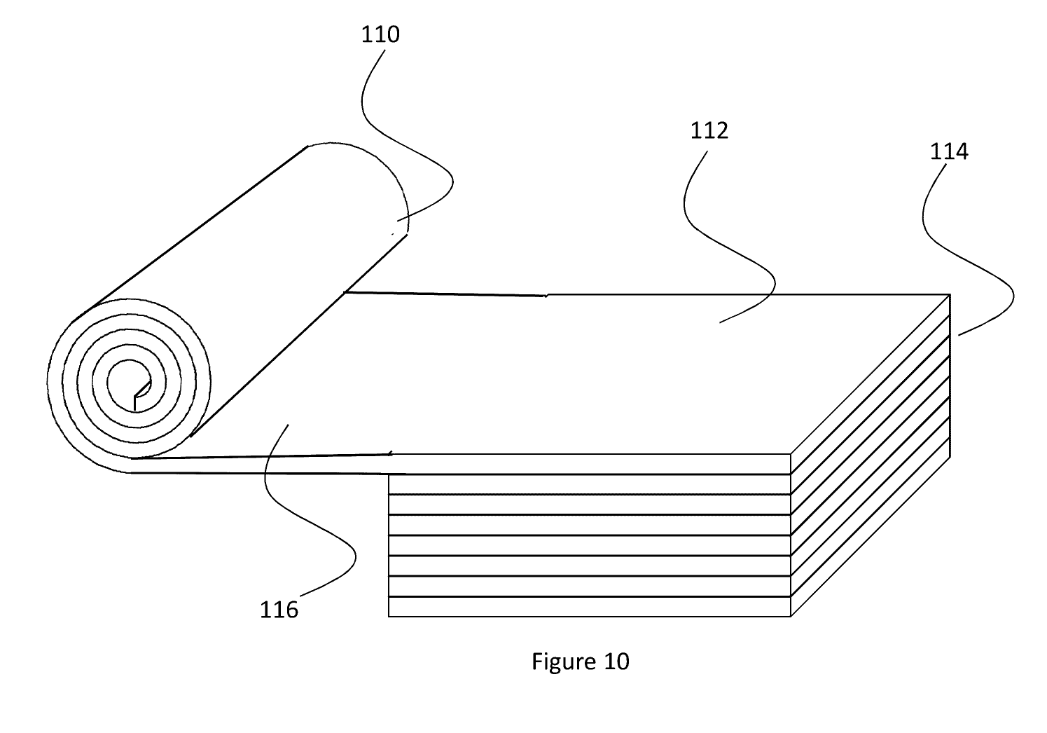

FIG. 10 shows the process of adding a layer of foil 112 from the supply roll 110 to the build area 114, where it will be cut and selectively joined to the previous layer.

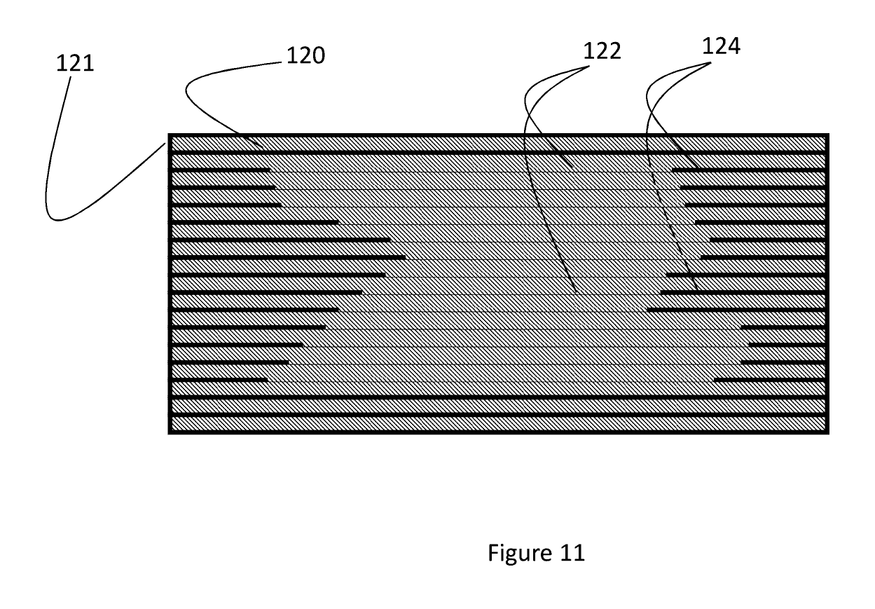

FIG. 11 shows a cross section of an object 121 made of layers 120. The masking layer 124 between layers is present only in areas that will not become a part of the object. No masking is done in areas 122 that will become a part of the built object. Upon completion of the building and processing of the masking layers, the object will be heated and compressed as a solid object and all areas in all layers that do not have a masking layer will be joined into each other to become a brazed solid object.

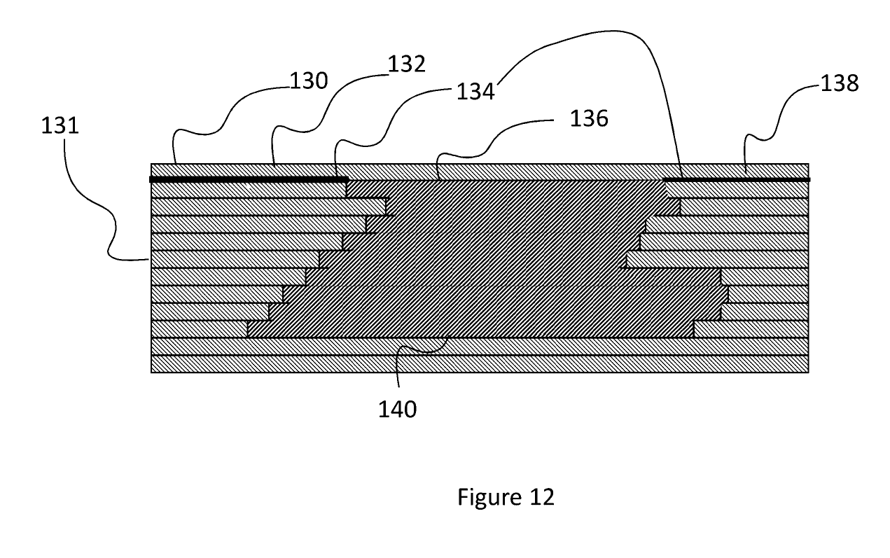

FIG. 12 shows a cross section of an object 131 being built where the layers are joined to each other one by one. Layer 132 has just been laid in place and its masking layer 134 has just been processed so that the areas that should be joined to the previous layer 136 do not have a masking material, while the areas that are not to be joined to the previous layer 130, 138 have their masking layers in place. At this stage heat and pressure are applied to the top of the object, and the new layer 132 is selectively joined to the bulk 140 of the object.

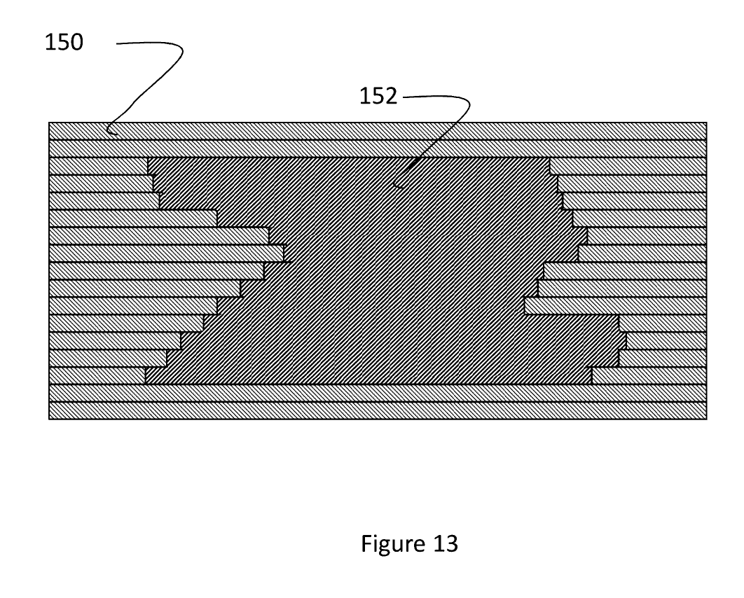

Attention is now called to FIG. 13 showing a cross section of an object 152 that has been fully printed and requires the excess material 150 to be removed. There are various ways to remove the excess material. Some non-limiting example removal methods are described as follows:

One method of removing excess layer material is etching using a chemical, such as sodium hydroxide, that dissolves the aluminum. The surface area of the unjoined material is much larger than the surface area of the joined body material, and the etching rate is dependent upon the contact surface between the etchant and the material. As the un-joined layers are not fused to each other, fluid can penetrate using capillary forces in between the layers until it reaches the bulk object where it slows down. By controlling the etching time, the user of this embodiment can cause all of the unjoined material to dissolve while the joined body preserves its shape and is only slightly etched, and the slight amount of etching may be the amount needed to smooth the “stair-like” surface resulting from the manufacturing process.

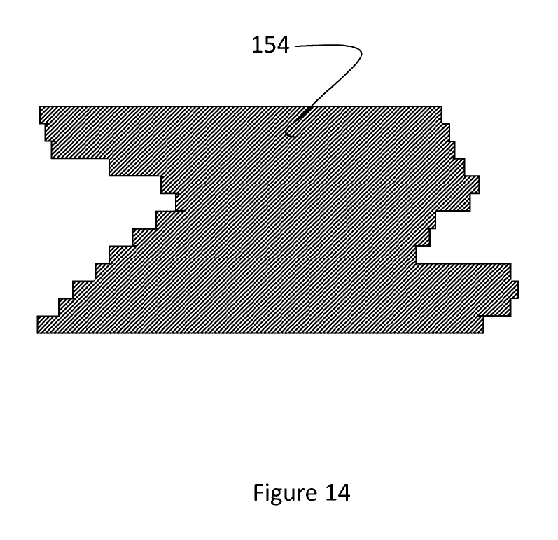

FIG. 14 shows the cleaned object after the excess material 154 has been removed.

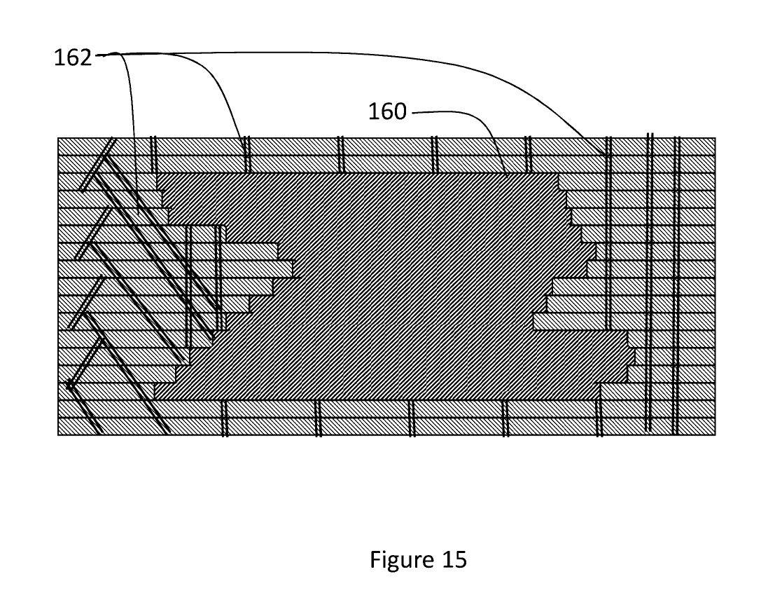

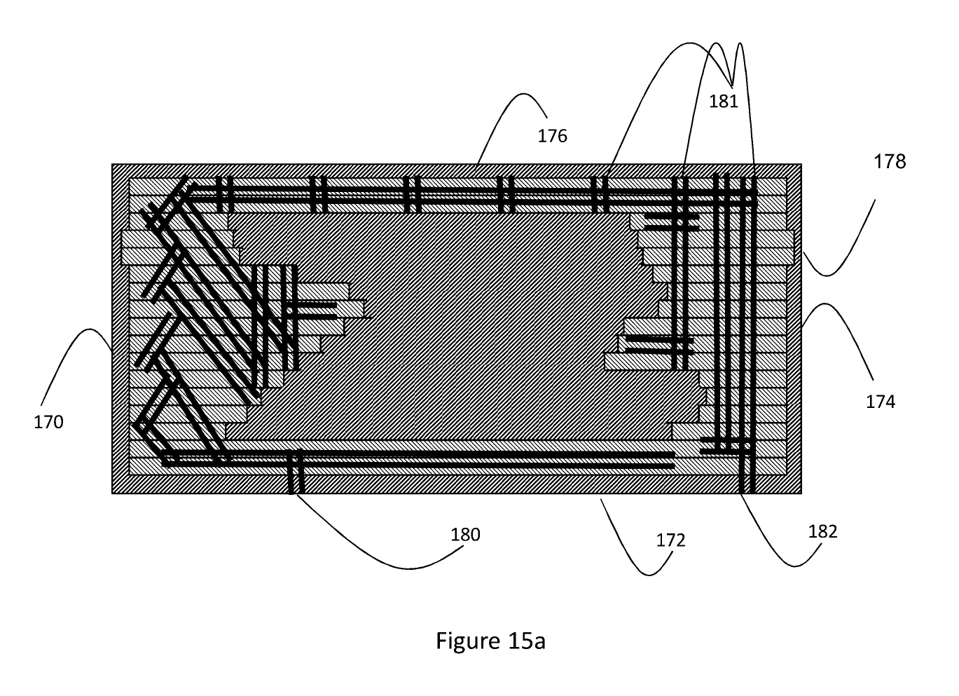

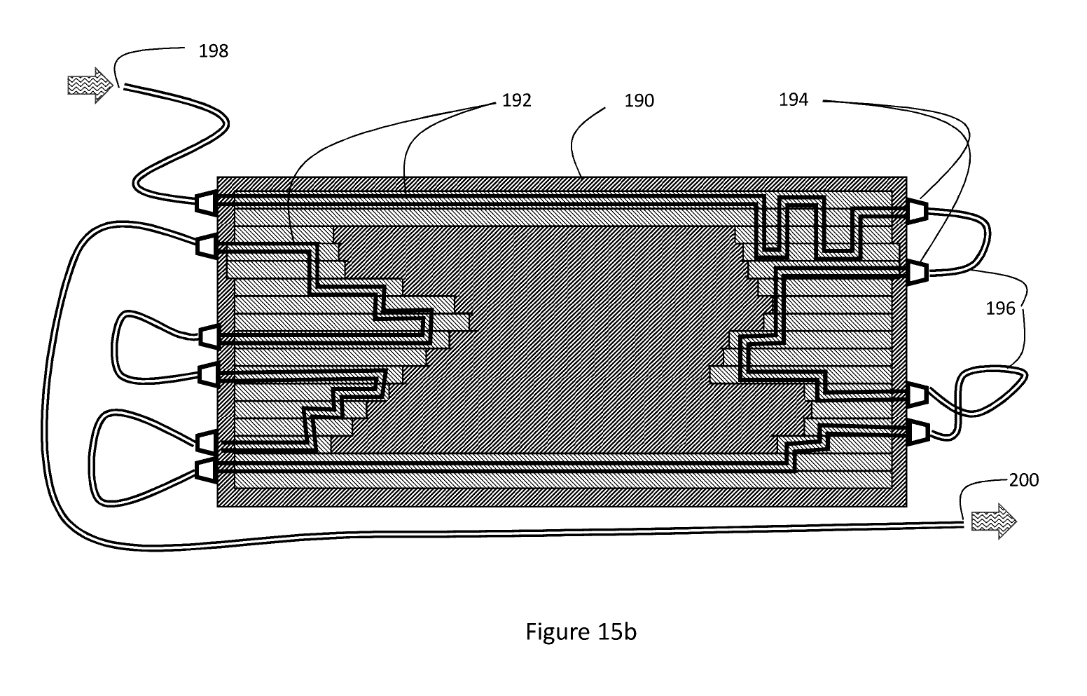

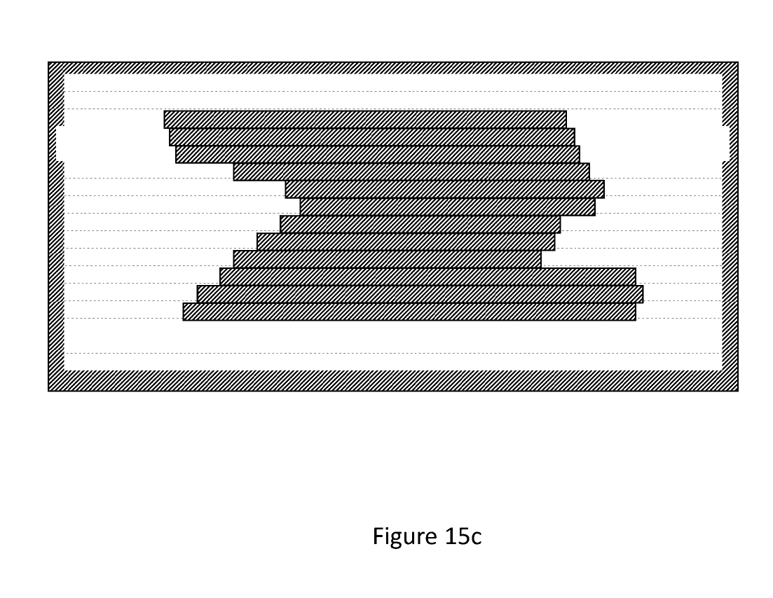

FIG. 15 shows another method to accelerate the penetration of the etchant, in addition to the use of capillary force. The un-brazed, masked areas in each layer that need to be removed ae are perforated allowing the etchant to reach deep into the built volume and in between the layers. These perforations can be cut by a laser during the build process or can be pre-cut in the raw material. The perforation drilling process can be done by the same laser that processes the masking layer, or by a dedicated machining laser. The holes can be patterned to be random in each layer or can be patterned to combine into continuous tunnels 162 through the layers. While the etchant has substantial access to the non-brazed layers, it has only marginal access to the object 160 and does not damage it.

Another method of removing excess material is electrochemically dissolving the aluminum using electric current within an electrolyte bath. The electrolytic process works on the surface of the material and the surface area of the unjoined layers is much larger than that of the bulk material.

FIG. 15A shows a preferred embodiment for removal of the support material in any of the chemical processes described above so that the chemical materials are contained within closed compartment and are not free to spill around the workpiece and the machine. This embodiment is important if the machine of the present invention is to be used in a shop environment, rather than in an industrial production floor. An encapsulating shell that is a box 170 made of the build material during the building process with external dimensions that are preferably equal to the build size of the machine, is built, layer by layer, around the model or models. The shell has a bottom 172, side walls 174 and top 176. The shell totally encapsulates the models and the removable supports.

The shell is preferably built so that at least 2 intersections of the etchant tunnels 181 with the side walls and top of the shell are left open as cylindrical holes in the shell, preferably in the bottom of the shell. These two or more holes serve as input (180) and output (182) channels for the etchant to be pumped into and out of the shell.

The layout of the tunnels within the shell is preferably designed as a manifold, causing the etchant to split upon entrance into the input port of the shell (180) to a plurality of sub-tunnels that eventually converge back to a single tunnel coming to the out-port 182.

Preferably, the machine has the etchant flowing mechanism (container, pump, tubing) built into the machine and directed to the in-port 180 and the out-port 182, so that upon termination of the building process, the etchant can be pumped into the shell without a need to move and handle the work piece.

Alternatively, as shown in FIG. 15b, the tunnels 192 can reach the shell 190 in several places in the shell, in the side walls and the top. The workpiece can then be removed from the machine to a side surface or bench to enable the use of the machine for a new model—and the etching system can be located on that other bench and not be a part of the machine. In such embodiment, the holes around the the shell can be labeled during the build process (by marks embedded in the 3D file to appear on the shell) as in-port and out-port of channels, the user can thread inserts 194 into these holes to enable fitting flexible tubes 196, and the etchant can be pumped (pump not shown) and flow into 198 and out of 200 the shell and pass through the tunnels. As the shell is typically made of aluminum, the insert 194 can be self-threading and threaded into the holes with or without preparation of a thread in the hole of the shell.

The shell is built with a relatively thick wall of typically 5 mm, and has a weakened strip region (labeled 178 in FIG. 15A) under the top of the shell where the wall thickness is made significantly smaller. This weakened strip region is used at the end of the etching process to enable tearing the shell open by pulling its lid upwards or twisting it by force, so that the cleaned and disconnected models can be removed. FIG. 15c shows the shell and the encapsulated model after etching out the support material and before opening the shell.

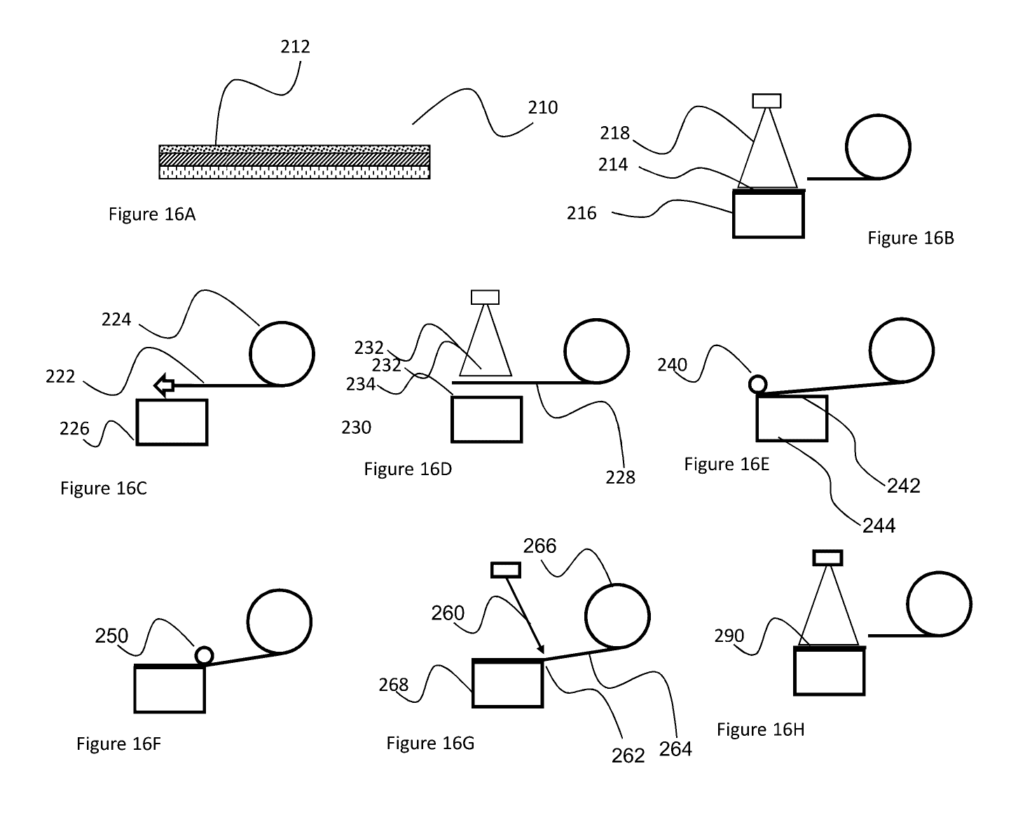

FIG. 16 A repeats the cross section of a structure 210 which may be one of the possible raw material structures illustrated in FIG. 3. The top layer 212 is a pre-fabricated masking layer that is selectively ablated prior to the placement of the next layer thereon. The selective ablation ensures that only parts that belong on the object being formed will be brazed.

FIG. 16B shows an ablation of the top layer 214 of the built stack of layers 216 where a laser beam 218 ablates the masking layer of the last layer (not labeled for clarity) that was placed and brazed. This ablation is preferably done in an atmosphere that is clean of oxygen so that the substrate layer that is exposed by the ablation does not oxidize and remains exposed ready to be brazed with the new layer. This protected atmosphere is preferably maintained throughout all the steps described of the method associated with this figure.

FIG. 16C shows a foil 222 coming from a raw material roll 224 being pulled to cover the built stack 226 and is kept slightly above it. Accordingly, foil 222 does not make contact with the built stack 226 at this stage.

FIG. 16D shows a step of perforating the foil 228 while suspended above the built stack 230. The perforation is done with a laser beam 232 that perforates holes in the areas that will not eventually become a part of the built object. The perforation is done while the foil 228 is suspended above the stack 230 in order to avoid damaging the previous layer 234 and avoid losing heat energy into the built model. If the perforating beam is focused on the foil, the space between the foil and the body under it also keeps the focal point away from the body of the object. The perforating is done in order to create passages for the etching fluid to easily access the regions that should be etched and removed after the building process. The amount of material that is removed to make the holes is calculated to be as much material as possible while still maintaining adequate strength of the foil for the continuation of the process.

FIG. 16E shows the beginning of the joining step, where a heated cylinder 240 is pressed against the new layer 242, pressing it down onto the stack of previous layers 244. The temperature of the cylinder 240 is above the melting point of the melting layer and below the melting point of the structural layer, so that the melting layer instantly melts. In the areas where the masking material on the previous layer has been ablated (FIG. 16B), the molten material wets the structural material of the previous layer and the new layer is joined onto the previous layer. In the areas where the masking material has been left, the molten material does not wet the previous layer, and the new layer remains separated from the previous layer. The hot cylinder 240 rolls over the new layer 242 continuing to melt and selectively join the layers.

FIG. 16F shows the end of the rolling process, where the hot cylinder 250 has completed the joining of the layer.

FIG. 16G shows the laser beam 260 cutting the end 262 of the foil 264 and disconnecting the supply roll 266 from the built object 268. The supply roll is now ready to supply the foil for the next layer.

FIG. 16H shows the step of ablating the masking material of the new layer 290, in preparation for the next layer, such completes the building cycle that started with the ablation of the previous layer (FIG. 16B).

The step of ablation (FIGS. 16B and 16H) can be replaced in other embodiments of the invention that were described above by other ways of making the joining selective. More is now discussed with respect to the building process.

In all embodiments of this invention, a new layer is selectively joined to the previous layer, where the selectivity is created by enabling or disabling the wetting of one layer to another. Two layers will be joined to each other only in areas where a melting layer comes in contact under pressure with a structural or a melting layer in the absence of masking between them.

The mask can be selectively generated during the process. Alternatively, the mask can be pre-fabricated in the raw material and selectively removed during the manufacturing processes.

The mask can be generated during the process by causing a local chemical reaction between the foil material and its surrounding gases. For example, an aluminum foil such as the material of a structural layer or the surface of a melting layer, which is initially free of surface oxides, can be selectively oxidized by heating with a laser beam in the presence of oxygen. While oxide-free aluminum surface can generally be wetted by melted aluminum alloy such as 12% silicon aluminum alloy, an oxidized surface of the same aluminum has significantly lower ability to be wetted under the same conditions.

A pre-fabricated mask can be selectively removed during the process by causing local ablation of the mask using a suitable (typically pulsed) laser beam. A typical pre-fabricated mask can be created by anodizing the surface of an aluminum foil, or by coating with TiN (Titanium Nitride) compound.

The object built in this process is a solid body of material, typically aluminum, that is made of sheets of material joined to each other.

The joining is done by heating the top layer beyond the melting temperature of its melting layers, and compressing it onto the previous layer.

The joining can also be done placing the whole stack of layers, after the masking layers have been processed, under pressure and heat that will join the whole object as one body.

The geometry of the built object is obtained by causing the layer to join onto each other only in areas that are to become a part of the object.

The selective joining is obtained by maintaining at least one patterned masking layer between each pair of layers while heating and compressing.

The masking layers are either selectively generated during building, or are selectively removed from a pre-fabricated mask during building.

The selective masking can be done by heating and oxidizing the layer using a laser beam, and the selective mask removal can be done by heating and ablating a pre-fabricated mask using a laser beam.

The joining of the layers can be done layer by layer, or can be done in bulk after the layers have been stacked and their masking layers prepared.

Following the joining step, the excessive material has to be removed. One method of removing the excess material is by etching it away, using the fact that the excessive material is made of separate layers while the object is made of a joined material.

An alternative method of selectively joining metal sheets is to use a laser beam to selectively remove the melting layer by ablation. In the absence of the melting layer, no joining would occur when the material is compressed and heated.

The following preferred embodiments that are described and illustrated in this application: One preferred embodiment uses a method of building three dimensional metal objects in layers, by selectively masking layers against wetting and non-selectively compressing and heating them. In this embodiment, the top layer may be joined to the previous layer before being covered by a next layer. Alternatively, all the layers may be masked separately and joined as a single body. As another option, the masking is done by an additive process where material is added to the layer. As still a further option, the masking is done by a subtractive process where material is removed from the layer.

The above method may include a step of applying etchant to the built volume after all layers are selectively joined. The method may further include introducing holes in each layer so that the holes combine to inter-layer tunnels. The method may still further include pumping etchant through said tunnels. The method even further include building a joined shell around the models. The method may also include having at least some of the tunnels reach out through the sides of the shell. The method may include further the holes being at the bottom of the shell and the system being configured to pump etchant into and out of the model through the holes. The method may yet further include the tunnels reaching out through the sides of the shell and configured to accept a sealing insert. The method may even further include the inserts being interconnected with flexible tubing. The method may also include having a band of a significantly reduced wall thickness essentially close to the top of the shell.

Another preferred embodiment uses a multilayered metal foil comprising at least a structural layer, at least on melting layer, and at least one masking layer. The metal foil may have one structural layer and two melting layers on both of its sides. The metal foil may have one structural layer, one melting layer on one of its sides, and a masking layer on its other side. The metal foil may have at least one melting layer, at least one structural layer on one of its sides, and a masking layer on its other side. The metal foil may have one structural layer, one melting layer on one of its sides, and a masking layer on its other side. The metal foil may have one structural layer, two melting layers on both sides, and a masking layer on one of the two melting layers. The metal foil may have one structural layer, two melting layers on both sides and a masking layer on each of the two melting layers.

Another preferred embodiment is a three dimensional printing system using the above material as raw material.

Another preferred embodiment uses the method discussed above and adds the step of selective perforating the parts of the foil that do not belong to the built object prior to its application. The method could add the step of selectively ablating a pre-fabricated melting layer and non-selectively compressing and heating the treated layers.

Another preferred embodiment uses a model building machine that has means to place layers of sheet metal on top of each other, means to selectively coat each layer with wetting preventing material, means to heat and compress the layers to a level of brazing, and means to cause etchant fluid to flow between the non-wetted areas of the layers and dissolve them.

Having thus described exemplary embodiments of the invention, it will be apparent that various alterations, modifications, and improvements will readily occur to those skilled in the art. Alternations, modifications, and improvements of the disclosed invention, though not expressly described above, are nonetheless intended and implied to be within spirit and scope of the invention. Accordingly, the foregoing discussion is intended to be illustrative only; the invention is limited and defined only by the following claims and equivalents thereto.

What is claimed is:

1. A method of building at least one three dimensional metal object, the method comprising:
setting in place a first foil having at least one structural layer and at least one melting layer;
setting in place a second foil on the first foil, the second foil having at least one structural layer and at least one melting layer;
designating as first areas regions of the first and second foils to remain unjoined to each other;
compressing and heating the first and second foils so that second areas of the first and second foils, distinct from the first areas, become joined to each other by brazing; and
removing the first areas to form at least one three dimensional object.

2. The method of claim 1 further comprising:
setting in place a third foil on the second foil, the third foil having at least one structural layer and at least one melting layer;
designating as third areas regions of the second and third foils to remain unjoined to each other;
compressing and heating the second and third foils so that fourth areas of the second and third foils, distinct from the third areas, become joined to each other by brazing; and
removing the third areas to form the at least one three dimensional object.

3. The method of claim 2, wherein one step of compressing and heating joins the first and second foils, and an additional step of compressing and heating joins the second and third foils.

4. The method of claim 2, wherein one step of compressing and heating joins more than two foils.

5. The method of claim 1, wherein masking layers cover the foils in the first areas.

6. The method of claim 5, wherein the masking layers are made by removing masking layer material from the foils except in areas where the masking layer is to be present during the compressing and heating.

7. The method of claim 5, wherein the masking layers are made by adding masking layer material to the foils only in the areas to remain unjoined after the compressing and heating.

8. The method of claim 1, wherein before the compressing and heating the melting layers are removed by ablation in the first areas.

9. The method of claim 1, wherein the areas of the foils are removed by etching.

10. The method of claim 5, further comprising:
perforating the foils in the areas intended to be covered by the masking layers.

11. The method of claim 5, further comprising:
perforating the foils in the areas covered by the masking layers.

12. The method of claim 1, wherein the compressing and heating forms at least one shell encapsulating a portion of the foils from which the at least one three dimensional object is formed.

13. A three dimensional metal object built by the method of claim 1.

14. A three dimensional metal object comprising:
multiple metal sheets;
wherein the metal sheets are joined together by selective brazing.

15. A masked brazing foil comprising:
at least one structural layer;
at least one melting layer; and
at least masking layer.
